(19) United States
(12) Patent Application Publication
(10) Pub. No.: US 2009/0230897 A1
(43) Pub. Date: Sep. 17, 2009

(54) Electric motor

(75) Inventor: Norbert Coenen, Mönchengladbach (DE)

Correspondence Address: K&L Gates LLP, 214 N. TRYON STREET, HEARST TOWER, 47TH FLOOR, CHARLOTTE, NC, 28202, US

(73) Assignee: Oerlikon Textile GmbH & Co. KG, Monchegladbach (DE)

(21) Appl. No.: 11/989,554

(22) PCT Filed: May 18, 2006
(86) PCT No.: PCT/EP2006/004717

§ 371 Date: Jan. 28, 2008

(30) Foreign Application Priority Data
Jul. 27, 2005 (DE) 102005035055.0

(51) Int. Cl. H02P 29/00; H02P 3/22; H02K 7/09

(52) U.S. Cl. 318/369; 318/379; 310/90.5

(57) ABSTRACT

An electric motor for a textile machine can be operated as a generator if the supply voltage fails. The electric motor comprises a rotor configured as the motor armature and a motor phase control circuit comprising a plurality of semiconductor components wherein the electric motor can be short-circuited if a predeterminable limit value is passed during generator operation. The motor circuit causes the short-circuiting on passing the limit value by activating one or more of the semiconductor components. The multi-phase electric motor is used as the single drive of a rotor of the textile machine. wherein the semiconductor components of the phase control bridge. on passing a predeterminable limit value, contactlessly short-circuit the electric motor to brake the electric motor.

### CROSS-REFERENCE TO RELATED APPLICATIONS

This application claims the benefit of German patent application 10 2005 035 055.0, filed Jul. 27, 2005, herein incorporated by reference.

### BACKGROUND OF THE INVENTION

The present invention relates to an electric motor, in particular for a textile machine, which can be operated as a generator if the supply voltage fails, and to the use of the electric motor as a single drive for a rotor of the textile machine.

When using electric motors as the drive of rotors, in particular rotors for textile machines, which are configured as armatures of the electric motor, it is necessary to bring the electric motor, which can be operated as a generator if the supply voltage fails, to a standstill within a certain time to avoid damage to the bearing of the rotor from wobbling movements when the rotor runs down until it is at a standstill.

A multi-phase electric motor, as the drive of a rotor, is known from the published application German Patent Publication DE 44 21 406 A1 and is configured as the spinning rotor of an open end rotor spinning machine. The electric motor works as a generator if the supply voltage fails until the electric motor is braked by short-circuiting on passing a critical limit value, at which the maintenance of the generator operation is no longer sensible. The motor circuit of the electric motor comprises semi-conductor components, which are responsible for the phase-wise clocking of the current flow and the current flow direction for the motor windings. Moreover, the motor circuit comprises two relays which, if a voltage failure occurs, in each case short-circuit a line run, of which the one line run has a load resistor. After closing the one relay, the line run leading to a direct current source is interrupted in the second relay.

The direct current source is used here for the current supply of the electric motor. In this manner, the current produced by the induced voltage when braking the electric motor is guided via the line run to the load resistor. By a corresponding selection of the line resistor, the braking energy produced is reduced via the load resistor.

It has proven to be a disadvantage that the use of relays or switches increases the costs of the system and takes up a relatively large amount of installation space. In addition, when the relay is used, current constantly flows through the relay coil, so the relay does not drop out. Moreover, mechanical switches are subject to symptoms of wear, which are increased by arcing and general susceptibility to faults in relation to mechanical influences. In addition, switches and relays only operate with a limited speed.

### SUMMARY OF THE INVENTION

The object of the present invention is to enhance the operating reliability of the electric motor as well as its use as a single drive of a rotor of a textile machine from the point of view of enhanced operating reliability.

This object is achieved according to the invention by providing an electric motor, in particular for a textile machine, which can be operated as a generator if the supply voltage fails. The electric motor comprises a rotor configured as the armature of the electric motor and a motor circuit for the phase control of the multiphase electric motor, which comprises a plurality of semiconductor components wherein the electric motor can be short-circuited if a predeterminable limit value is passed during generator operation. In accordance with the invention, the motor circuit is set up in such a way that the short-circuiting on passing the limit value can be carried out by activating one or more of the semiconductor components comprised by the motor circuit. According to another aspect of the invention, the invention provides for the use of the multi-phase electric motor as the single drive of a rotor of the textile machine, wherein the semiconductor components of the phase bridge provided for the phase control of the electric motor, on passing a predeterminable limit value, contactlessly short-circuit the windings of the electric motor to brake the electric motor.

It is provided that the motor circuit is set up in such a way that the short-circuiting, on passing the limit value, can be carried out by activating one or more semiconductor components comprised by the motor circuit. The use of the semiconductor elements comprised by the motor circuit for short-circuiting and therefore for braking the electric motor has the advantage that the installation of one or more additional components can thereby be dispensed with so the costs of the electric motor can be reduced compared to electric motors according to the prior art.

The semiconductor components of the phase bridge used during normal operation for the phase control are preferably used for short-circuiting the electric motor, so the use of additional switching components, for example in the form of relays, switches or additional semiconductor components and the optionally associated active connections is not necessary. In addition, no additional insulation space is necessary which would increase the structural shape of the electric motor.

Moreover, the mechanical switches or relays do not have the safety, which is provided by contactless switching on the basis of a corresponding activation of the semiconductor components. At high rotor speeds, in particular, the virtually delay-free switching if the supply voltage of the electric motor fails is particularly important to avoid damage. The contactless short-circuiting of the electric motor by means of semiconductor elements on passing a predeterminable limit value during generator operation makes it possible to fix the limit value in such a way that directly before reaching the limit value, the generator operation is ended by the short-circuiting and the electric motor is braked to avoid damage to the electric motor and/or devices connected to the electric motor. The predeterminability of the limit value in particular allows flexible adaptation of the switching off time as a function of the different load situations of the electric motor according to the invention in generator operation. Thus, the time of switching off can be varied according to the respectively present operating conditions when the supply voltage of the electric motor fails.

The semiconductor components being used for the phase control of the electric motor may preferably be activated in such a way that the windings of the electric motor are short-circuited. The requirement for an additional controllable resistor, which has to be adaptable to the mass inertia of the rotor, to discharge the voltage produced during generator operation, is not provided.

In particular, the motor circuit may comprise at least one energy store which, after passing the predeterminable limit value, maintains the activation of the semi-conductor elements in that the energy store supplies the necessary voltage to operate the semiconductor elements. In this manner, the short-circuit can be maintained until the rotor is at a standstill. For this purpose, the energy store may be designed as at least one capacitor which is designed as a function of the duration of the braking process with a corresponding capacity to implement the maintenance of the activation of the semiconductor components.

In particular, the motor circuit may be set up in such a way that the semiconductor components can be activated with a signal reflecting the operating state. For example, for this purpose, the commutation signal can be used for phase control, the presence of which at the motor circuit reflects the operating state as the drive motor. Alternatively, an additional signal can be generated, which reflects the operating state and is used to activate the semiconductor components.

The electric motor may advantageously have a measuring device for monitoring the actual values, which is in operative connection with a control device. The control device may be designed as a microprocessor and comprise a rewritable memory, whereby it is made possible to input and store the limit values to be monitored with suitable input means. The control device evaluates the measured values obtained from the measuring device and compares them with the predeterminable limit values. The activation of the semiconductor components for short-circuiting the windings of the electric motor takes place during generator operation with the aid of this desired/actual comparison. The limit value may preferably be fixable above a sensible threshold value of the electric motor working in generator operation to maintain operation of the control device and the semiconductor components of the motor circuit.

The measuring device may preferably be designed as a device for voltage and/or current measurement or output measurement, so that, on passing the limit value for the output supplied in generator operation or for the generated current, the short-circuiting of the windings is initiated. Alternatively, the measuring device may be designed as a rotational speed measuring device so that, on passing a limit rotational speed, the short-circuiting of the windings of the electric motor operating in generator operation takes place. The limit rotational speed value may, for this purpose, be fixed above a threshold value of the rotational speed, which is sensible for maintaining the supply voltage of the control device and the semiconductor components so operating reliability can be increased.

According to a further embodiment, the motor circuit may comprise a delay member, by means of which a time interval can be predetermined as the limit value and once it has been exceeded, the short-circuiting takes place by means of automatic activation of the semiconductor components. The delay member is not activated until the change-over into generator operation by suitable activation by means of the signal reflecting the operating state. At the end of the predeterminable time interval, the automatic activation of the semiconductor components takes place in such a way that these are switched through, so the short-circuit of the windings is implemented. The duration of the time interval can be input as a function of the run-down behavior of the rotor in generator operation of the electric motor, which is substantially determined by the mass inertia of the rotor.

Advantageously, the semiconductor elements used for short-circuiting the windings can be implemented as transistors. These are the transistors of the phase bridge generally used for the phase control of the electric motor, by means of which the phase-wise clocking of the current flow and the current flow direction takes place. For this purpose, the transistors can be designed as field effect transistors or bipolar transistors. The corresponding use of thyristors could equally be considered.

Furthermore, the rotor may be contactlessly mounted. For this purpose, for the contactless mounting of the rotor, the bearing can be designed as a magnetic bearing. The generator operation allows the magnetic bearing function to be maintained, the motor being short-circuited on passing the limit value to avoid unnecessary wear or possible damage to the magnetic bearing through wobbling movements of the rotor which is running down.

According to another aspect of the invention, it is provided that the semiconductor components of the phase bridge provided for the phase control of the electric motor, on passing a predeterminable limit value, contactlessly short-circuit the windings of the electric motor to brake the electric motor in order to thus avoid unnecessary wear or possible damage to the electric motor or devices connected thereto.

Advantageous developments can be inferred from the electric motor being designed as the single drive of a rotor of a textile machine. In particular, the textile machine may be an open end rotor spinning machine, which has a spinning rotor, which may also be configured as a shaftless spinning rotor. The spinning rotor may be configured in the use according to the invention as a permanent magnet armature of the electric motor.

### BRIEF DESCRIPTION OF THE DRAWINGS

Further details of the invention can be inferred from the embodiment described below with the aid of the drawings, in which:

FIG. 1 shows a block diagram of the motor circuit of an electric motor according to the invention.

### DETAILED DESCRIPTION OF THE PREFERRED EMBODIMENT

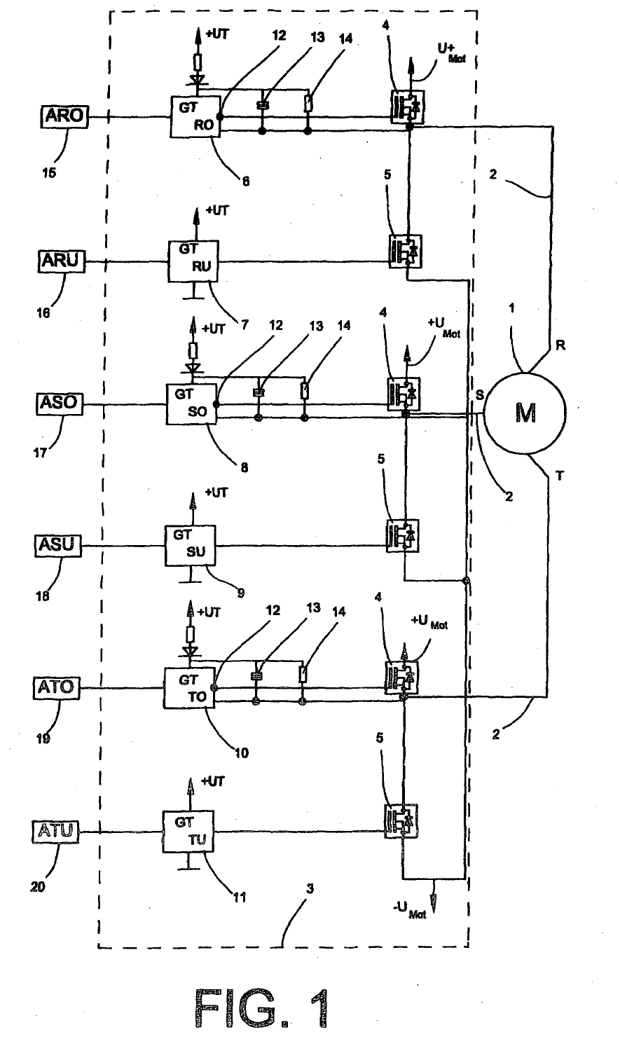

The view in FIG. 1 shows a 3-phase electric motor 1, which can be used, for example, in a textile machine, as a single drive of a rotor. The rotor is contactlessly mounted in the embodiment presently described. For the contactless mounting of the rotor, a magnetic bearing is provided, which can be designed actively or passively. For the contactless mounting, a gas bearing or a combined gas/magnetic bearing may also be used. The rotor is designed as a permanent magnet armature of the electric motor 1. The electric motor 1, for each phase R, S, T, comprises a winding, which is supplied via supply lines 2 with a supply voltage V_{Mot}.

To activate the electric motor 1, a motor circuit 3 is provided, which is in operative connection with a control device, not shown. The control device is, for example, a microprocessor and an overwritable EEPROM as the memory.

The motor circuit 3 comprises a plurality of semiconductor components 4, 5, 6, 7, 8, 9, 10, 11, which are used in a known manner for the control of the phases of the 3-phase electric motor 1 during normal operation of the drive of the rotor. Use in a textile machine, for example in an open end rotor spinning machine as the single drive of a spinning rotor is considered here, in particular. To activate the respective phase R, S, T, the control device is connected via inputs 15, 16, 17, 18, 19, 20 to the motor circuit 3. The respective inputs 15, 16, 17, 18, 19, 20 have been designated according to their allocation to the respective phase R, S, T. The semiconductor components 4, 5, 6, 7, 8, 9, 10, 11 are designed as lower transistors 4 and upper transistors 5 with associated gate drivers 6, 7, 8, 9, 10, 11.

In the block diagram shown in FIG. 1, the reference numeral 15 designates the input for activating an upper transistor 4 of the phase R (ARO), 16 the input for activating a lower transistor 5 of the phase R (ARU), 17 the input for activating an upper transistor 4 of the phase S (ASO), 18 the input for activating the lower transistor 5 of the phase S (ASU), 19 the input for activating the upper transistor 4 of the phase T (ATO) and 20 the input for activating the lower transistor 5 of the phase T (ATU). The upper and lower transistors 4, 5 used in the presently described embodiment are designed as field effect transistors. Alternatively, bipolar transistors or thyristors can also be used.

Gate drivers 6, 7, 8, 9, 10, 11 are arranged mounted downstream from the respective inputs 15, 16, 17, 18, 19, 20 and have been designated according to their allocation to the respective phase R, S, T. Here, 6 designates the gate driver of the upper transistor 4 of the phase R (GTRO), 7 the gate driver of the lower transistor 5 of the phase R (GTRU), 8 the gate driver of the upper transistor 4 of the phase S (GTSO), 9 the gate driver of the lower transistor 5 of the phase S (GTSU), 10 the gate driver of the upper transistor 4 of the phase T (GTTO) and 11 the gate driver of the lower transistor 5 of the phase T (GTTU). The upper gate drivers GTRO 6, GTSO 8 and GTTO 10 in each case have a negation function 12, by means of which a control signal for activating the respective upper transistor 4 is sent to the control electrode of the upper transistors 4 of the phases R, S, T. Said semiconductor components 4, 5, 6, 7, 8, 9, 10, 11, 12 are used for the phase control of the electric motor 1 during proper operation as a drive and are familiar to the person skilled in the art with respect to their application and their arrangement in terms of circuitry. The gate drivers 6, 7, 8, 9, 10, 11 are supplied with a supply voltage UT.

A capacitor 13 and a resistor 14, which are in turn connected via lines with the inflow of the respective upper transistor 4 of the individual phase R, S, T are allocated, in each case in parallel connection, to the gate drivers 6, 8, 10.

Furthermore, a measuring device, not shown, is provided, which is connected to the supply lines 2 of the respective phases R, S, T and the control device. The measuring device is used in the embodiment described in FIG. 1 for the continuous measurement of the output supplied in generator operation by the electric motor 1 if the supply voltage U_{Mot} fails. The measuring device passes the measured values to the control device, which evaluates them and passes the results of the evaluation in the form of a control signal, which reflects the respective active operating state, to the inputs 15, 17, 19. The measuring device may alternatively be designed in such a way that the rotational speed of the rotor of the electric motor 1 which is in generator operation, or the current output in generator operation, is monitored.

During the proper operation of the electric motor 1, the supply voltage U_{Mot} is available so that a corresponding commutation signal used for the phase control of the electric motor 1 is present at the inputs 15, 16, 17, 18, 19, 20 and corresponds to the control signal reflecting a proper operating state. This control signal with the logical value “1” is passed to the gate drivers 6, 8, 10. Passing the control signal to the gate drivers 6, 8, 10 means that the negation function 12 converts the value of the control signal from “1” to “0” and that the changed control signal is passed to the control electrodes of the respective upper transistors 4. The circuit of the upper transistors 4 is selected such that these are not switched through in the case of the present activation with the control signal of the value “0”.

If the voltage supply of the electric motor 1 fails, this brings about the automatic change-over of the electric motor 1 into generator operation. This ensures the maintenance of the operation of the control device, the motor circuit 3 and, in particular, the magnetic bearing of the rotor being used for contactless mounting. During generator operation, the rotational speed of the rotor continuously falls, which results in the falling of the output produced by the electric motor 1 in generator operation. This leads to the magnetic bearing function and the operation of the control device no longer being ensured on passing a predeterminable limit value of the output produced by the electric motor 1 in generator operation. The limit value preferably lies above a threshold value which is predetermined by the falling below of the necessary supply output for maintaining the magnetic bearing function and the operation of the control device. It is ensured in this manner that, if the supply voltage V_{Mot} of the electric motor fails followed by the change-over into generator operation, the braking operation is initiated before the threshold value is fallen below.

On passing the predeterminable limit value of the output produced by the electric motor 1 no control signal of the value “1” signaling the normal operating state is present any longer at the inputs 15, 17, 19, but the control signal adopts the logical value “0”. The control signal with the value “0” is then passed to the gate drivers 6, 8, 10 and is converted by the negation function 12 into the control signal with the value “1”. This brings about the activation of the upper transistors 4 of the respective phase R, S, T in such a way that these switch through and this leads to the contactless short-circuiting of the motor windings of the phases R, S, T. In this manner, the rotor is braked to prevent the magnetic bearing of the rotor in the electric motor 1 being subjected, due to wobbling movements, to unnecessary wear or possible damage in the event of an unbraked running down of the rotor in generator operation.

To maintain the activation of the upper transistors 4 of the short-circuit produced by the switching through, of the windings of the phases R, S, T during the braking of the rotor until it is at a standstill, it is necessary to provide the upper transistors 4 with a supply voltage beyond the time of the activation triggering the short-circuit. In order to maintain the through-connection of the upper transistors 4 beyond the time of the short-circuit, the capacitors 13 are used as energy stores. The capacitors 13 are charged by the voltage produced while the electric motor 1 is in generator operation. On entry of the control signal with the value “0” passed to the gate drivers 6, 8, 10 and with the control signal subsequently converted by the negation function 12 to the value “1”, the switched-through upper transistors 4 are supplied by the capacitors 13 with the required supply voltage for maintaining their switching state. The capacitive design of the capacitors 13 is determined according to the duration of the braking process of the rotor. The duration of the braking process may in this case be approximately in a range of a few milliseconds up to several seconds.

An alternative embodiment of the electric motor 1 according to the invention provides the activation of the lower transistors 5 in the above described manner to short-circuit the respective windings of the electric motor 1.

Furthermore, the associated capacitors of the gate drivers 6, 7, 8, 9, 10, with corresponding dimensioning of the capacitances, can be used as energy stores of the gate drivers 6, 8, 10 and the upper transistors 4 or of the gate drivers 7, 9, 11 and the lower transistors 5. In this manner, the component requirement can be additionally reduced.

Furthermore, instead of, or in addition to, the measuring device, a device for time control of the generator operation may be provided. The device may be configured in the form of a delay member and, within a predefined time interval after the changeover into generator operation, allows the signal leading to the short-circuit of the windings of the electric motor 1 to be produced by gate drivers 6, 7, 8, 9, 10, 11 to initiate the braking process of the rotor by short-circuiting the windings.

1. Electric motor (1), in particular for a textile machine, which can be operated as a generator if the supply voltage fails, comprising a rotor configured as the armature of the electric motor (1) and a motor circuit (3) for the phase control of the multiphase electric motor (1), which comprises a plurality of semiconductor components (4, 5, 6, 7, 8, 9, 10, 11), wherein the electric motor (1) can be short-circuited if a predeterminable limit value is passed during generator operation, characterized in that the motor circuit (3) is set up in such a way that the short-circuiting on passing the limit value can be carried out by activating one or more of the semiconductor components (4, 5, 6, 7, 8, 9, 10, 11) comprised by the motor circuit (3), wherein at the end of a predeterminable time interval, the automated activation of the semiconductor components takes place.

2. Electric motor (1) according to claim 1, characterized in that the semiconductor components (4, 5, 6, 7, 8, 9, 10, 11) being used for the phase control of the electric motor (1) can be activated in such a way that they short-circuit the windings of the electric motor (1).

3. Electric motor (1) according to either of claims 1 or 2, characterized in that the motor circuit (3) comprises at least one energy store (13) which, after the prederminable limit value has been passed, maintains the activation of the semiconductor components (4, 5, 6, 7, 8, 9, 10, 11).

4. Electric motor (1) according to claim 3, characterized in that the at least one energy store (13) is configured as a capacitor (13).

5. Electric motor (1) according to claim 1, characterized in that the motor circuit (3) is set up in such a way that the semiconductor elements (4, 5, 6, 7, 8, 9, 10, 11) can be activated by a signal reflecting the operating state.

6. Electric motor (1) according to claim 1, characterized in that the electric motor (1) has a measuring device for monitoring the actual values, which is in operative connection with a control device.

7. Electric motor (1) according to claim 6, characterized in that the control device is designed as a microprocessor.

8. Electric motor (1) according to either of claims 6 or 7, characterized in that the measuring device is designed as a device for voltage and/or current measurement.

9. Electric motor (1) according to either of claims 6 or 7, characterized in that the measuring device is designed as a rotational speed measuring device.

10. Electric motor (1) according to claim 1, characterized in that the motor circuit (3) comprises a delay member, by means of which a time interval can be predetermined as a limit value and once this has been exceeded, the short-circuiting takes place by means of automatic activation of the semiconductor components (4, 5, 6, 7, 8, 9, 10, 11).

11. Electric motor (1) according to claim 1, characterized in that the semiconductor components (4, 5) used to short-circuit the windings are designed as transistors (4, 5).

12. Electric motor (1) according to claim 11, characterized in that the transistors (4, 5) are designed as field effect transistors or bipolar transistors.

13. Electric motor (1) according to claim 1, characterized in that the rotor is contactlessly mounted.

14. Electric motor (1) according to claim 13, characterized in that for the contactless mounting of the rotor, the bearing is designed as a magnetic bearing.

15. A method of operating a textile machine, comprising the steps of providing a multi-phase electric motor according to claim 1, using the electric motor as the single drive of the rotor, wherein the semiconductor components (4, 5, 6, 7, 8, 9, 10, 11) of the phase bridge provide for the phase control of the electric motor (1), on passing a predeterminable limit value, and contactlessly short-circuit the windings of the electric motor (1) to brake the electric motor (1).

16. A method of operating a textile machine according to claim 15, characterized in that the limit value can be fixed above a threshold value for maintaining the operation of the control device and the semiconductor components (4, 5, 6, 7, 8, 9, 10, 11) of the electric motor (1) operating in generator operation.

17. A method of operating a textile machine according to either of claims 15 or 16, characterized in that the electric motor (1) is designed as the single drive of a rotor of a textile machine.

18. A method of operating a textile machine according to claim 17, characterized in that the rotor is designed as the spinning rotor of a rotor spinning machine.
